(19) United States
(12) Patent Application Publication
(10) Pub. No.: US 2010/0324166 A1
(43) Pub. Date: Dec. 23, 2010

(54) USING DISPERSION POLYMERS WITH NONIONIC CHARACTERISTICS AND FORMULATIONS TO REDUCE FRICTION

(75) Inventor: Jun Jim Wu, Houston, TX (US)

Correspondence Address: STREETS & STEELE, 13100 WORTHAM CENTER DRIVE, SUITE 245, HOUSTON, TX, 77065, US

(73) Assignee: CHAMPION TECHNOLOGIES, INC., Houston, TX (US)

(21) Appl. No.: 12/818,690

(22) Filed: Jun. 18, 2010

Related U.S. Application Data
(60) Provisional application No. 61/218,352, filed on Jun. 18, 2009.

(51) Int. Cl. C08L 33/26; C09D 5/14

(52) U.S. Cl. 523/122; 524/555

(57) ABSTRACT

This invention discloses, compositions of aqueous fluids comprising one or more dispersion polymer(s), wherein the dispersion polymer comprises 96 to 100 mole percent of one or more nonionic monomer units and 0 to 4 mole percent of one or more cationic or anionic monomer units; and has a molecular weight of at least 100,000. The invention also discloses the method(s) of using one or more such dispersion polymer(s), comprising adding to or mixing with the aqueous fluid a friction-reducing amount of the polymer(s), before, during or after a turbulent flow is induced. Nonionic dispersion polymers consistently render substantially greater extents of friction reduction than their ionic counterparts. A dispersion polymer (formed by dispersion polymerization) provides up to four times as much friction reduction as the same polymer in solution when used at the same dosage. Moreover, unlike ionic dispersion polymers, nonionic dispersion polymers are intrinsically compatible with charged oilfield species such as multi-valence brine(s), quaternary amine-based corrosion inhibitors and biocides.

### CROSS-REFERENCE TO RELATED APPLICATIONS

This application claims the benefit of U.S. Provisional Patent Application No. 61/218,352 filed on Jun. 18, 2009.

### BACKGROUND OF THE INVENTION

1. Field Of The Invention

This invention relates to aqueous fluids and the use of water-soluble dispersion polymers to reduce friction in aqueous fluid streams, such as the turbulent flow of fluids through a tubular string.

2. Background of the Related Art

During drilling or production, a fluid is often injected to a formation at a high velocity. The fluid moves either as a lamina or a turbulence in the pipe. In a laminar flow, the liquid travels at a constant speed with no directional fluctuation. In contrast, a turbulent flow has local variation of velocity with regard to that of the bulk. In this case, molecules move randomly so that local friction (or drag) increases. In this case, additional energy input is needed to sustain the velocity of the flow, which sacrifices both operation convenience and cost effectiveness. Therefore, there is extensive interest in reducing friction in these fluids. Anionic or cationic polymer dispersions have recently been disclosed to be suitable for friction reduction (or drag reduction, which is interchangeable in this invention), in part because of low operational cost arising from low bulk viscosity (that of the medium) at high solids content (e.g., 20%).

### BRIEF SUMMARY OF THE INVENTION

One embodiment of the invention provides a method of reducing friction in an aqueous fluid comprising adding a friction-reducing amount of one or more nonionic dispersion polymers into the aqueous fluid, wherein the one or more nonionic dispersion polymers have a molecular weight of at least 100,000. Optionally, the method may further comprise adding one or more charged species into the aqueous fluid, wherein the one or more nonionic dispersion polymers do not ionically interact with the charged species. Examples of the one or more charged species include, without limitation, a corrosion inhibitor and a biocide.

Another embodiment of the invention provides a method of reducing friction in an aqueous fluid comprising adding a friction-reducing amount of one or more dispersion polymers into the fluid, wherein the dispersion polymer has a molecular weight of at least 100,000, and wherein the dispersion polymer comprises no less than 96 mole percent of one or more nonionic monomer units and no greater than 4 mole percent of one or more ionic monomer units. In one option, the one or more ionic monomer comprises a cationic monomer selected from dimethylaminoethyl acrylate methyl chloride quaternary salt and dimethylaminoethyl acrylate benzyl chloride quaternary salt. In another option, the one or more ionic monomer comprises an anionic monomer selected from the group consisting of acrylic acid, methacrylic acid and 2-acrylamido-2-methylpropanesulfonic acid and the salts thereof. A preferred nonionic monomer is acrylamide. Additionally, the method may further comprise adding a corrosion-inhibiting amount of one or more charged corrosion inhibitors into the aqueous fluid, wherein the one or more nonionic dispersion polymers do not ionically interact with the one or more charged corrosion inhibitors.

A further embodiment of the invention provides an aqueous treatment fluid, such as a well treatment fluid, comprising water containing a treatment compound, such as a corrosion inhibitor, a biocide, or both, and a friction-reducing amount of one or more dispersion polymers, wherein the dispersion polymer comprises from 96 to 100 mole percent of one or more nonionic monomer units and from 0 to 4 mole percent of one or more cationic or anionic monomer units; and wherein the dispersion polymer has a molecular weight of at least 100,000. Optionally, the water may be selected from the group consisting of freshwater, saltwater, brine, seawater and combinations.

### BRIEF DESCRIPTION OF THE DRAWINGS

FIG. 1 is a graph of gel permeation chromatography (GPC) profiles of a nonionic dispersion polymer (JW00) and an anionic dispersion polymer having about 4 mol % (5 wt %) anionic monomer (JW05).

FIGS. 2A and 2B are graphs of friction reduction over periods of 2 minutes and 30 minutes, respectively, resulting from the use of a nonionic dispersion polymer (JW00) and an anionic polymer (JW05) solution (in NaCl 2 wt %, 15 mL) under the same conditions.

FIGS. 3A and 3B are graphs of friction reduction over periods of 2 minutes and 30 minutes, respectively, resulting from the use of a nonionic dispersion polymer (JW00) and a nonionic polymer solution based on the same nonionic polymer under the same conditions.

### DETAILED DESCRIPTION OF THE INVENTION

One embodiment of the present invention provides a method of reducing friction in an aqueous fluid comprising adding a friction-reducing amount of one or more nonionic dispersion polymers into the aqueous fluid, wherein the one or more nonionic dispersion polymers have a molecular weight of at least 100,000. Optionally, the method may further comprise adding one or more charged species into the aqueous fluid, wherein the one or more nonionic dispersion polymers do not ionically interact with the charged species. Examples of the one or more charged species include, without limitation, a corrosion inhibitor and a biocide.

The one or more nonionic dispersion polymers may be formed using one or more nonionic monomer species, such as an acrylamide monomer. Although polymers such as polyacrylamide may be prepared by inverse emulsion (water in oil) polymerization or other polymerization methods, the present invention is directed to “dispersion polymers”, meaning that the polymer was formed by dispersion polymerization. It should be recognized that a “polymer dispersion” may be prepared by physically dispersing one or more previously formed polymers into a continuous phase, but such a polymer dispersion is distinct from the present dispersion polymers. Dispersions of nonionic water soluble polymer particles formed through physically redispersing the polymer particles, inverse emulsion polymerization, or solution polymerization are distinctly different from the foregoing dispersion polymers, but may also be of benefit to reduce friction under turbulent flow conditions.

Another embodiment of the invention provides a method of reducing friction in an aqueous fluid comprising adding a friction-reducing amount of one or more dispersion polymers into the fluid, wherein the dispersion polymer has a molecular weight of at least 100,000, and wherein the dispersion polymer comprises no less than 96 mole percent of one or more nonionic monomers and no greater than 4 mole percent of one or more ionic monomers. In one option, the one or more ionic monomers comprise a cationic monomer selected from dimethylaminoethyl acrylate methyl chloride quaternary salt and dimethylaminoethyl acrylate benzyl chloride quaternary salt. In another option, the one or more ionic monomers comprise an anionic monomer selected from the group consisting of acrylic acid, methacrylic acid, 2-acrylamido-2-methylpropanesulfonic acid, and the salts thereof. Examples of suitable nonionic monomers may include 2-hydroxyethyl acrylate, 2-hydroxyethyl methacrylate, 2-hydroxypropyl acrylate, but a preferred nonionic monomer is acrylamide. Additionally, the method may further comprise adding a corrosion-inhibiting amount of one or more charged corrosion inhibitors into the aqueous fluid, wherein the one or more nonionic dispersion polymers do not ionically interact with the one or more charged corrosion inhibitors. In one option, the method further comprises adding a corrosion-inhibiting amount of one or more charged corrosion inhibitors into the aqueous fluid, wherein the one or more nonionic dispersion polymers do not ionically interact with the one or more charged corrosion inhibitors.

A further embodiment of the invention provides an aqueous treatment fluid comprising water containing a treatment compound, such as a corrosion inhibitor, a biocide, or both, and a friction-reducing amount of one or more dispersion polymers, wherein the dispersion polymer comprises from 96 to 100 mole percent of one or more nonionic monomers and from 0 to 4 mole percent of one or more cationic or anionic monomers; and wherein the dispersion polymer has a molecular weight of at least 100,000. As a non-limiting example, the water may be selected from the group consisting of freshwater, saltwater, brine, seawater and combinations.

The dispersion polymers described herein may be added to downhole tubular strings during various operations where it is desirable to reduce friction within the tubular string. Such a tubular string may include a pipe string, a casing string, or a capillary string. The friction reducing dispersion polymers may also be added to a fluid that will be passed through pipelines.

In this invention, it is disclosed that nonionic dispersion polymers consistently render substantially greater extents of friction reductions than their ionic counterparts. In addition, the state of a polymer at the time of injection into an aqueous fluid has a significant impact on the amount of friction reduction provided by the polymer. When a dispersion polymer is injected as a dispersion into an aqueous fluid, it leads to a significantly greater extent of friction reduction than if the same polymer is injected in solution form. Additional benefits of using nonionic dispersion polymers include their intrinsic compatibility with charged oilfield species such as multi-valence brines, corrosion inhibitors and biocides. As a result, a friction reducing nonionic dispersion polymer and another charged species do not interfere with each other, whether the charged species is a treatment compound or a component of the aqueous fluid, such as an aqueous treatment fluid. In contrast, ionic friction reducers (either cationic or anionic) may not be compatible with charged oilfield species. In some cases, additional steps must be taken, such as adding chelating agent to the aqueous fluid, in order to retain the performance of an ionic friction reducer and avoid precipitation resulting from anion-cation aggregation.

Aqueous fluids containing a friction reducing amount of one or more nonionic dispersion polymers, as disclosed herein, may be used in various applications where it is desirable to have reduced friction, such as friction or drag caused by turbulent flow conditions. For example, these applications may include, without limitation, slick-water fracturing during stimulation of oil producing formation and water injection during production to maintain reservoir pressure. The friction reducing dispersion polymers of the present invention are compatible with both fresh water and sea water because of the nonionic or very low ionic character of the polymers.

### EXAMPLES

### Example 1

### Preparation of a Nonionic Brine Dispersion Polymer (ID: JW00)

The following procedure was followed to prepare a nonionic brine dispersion polymer referred to herein as “JW00.” A three-neck flask (250 mL), equipped with a condenser and a mechanical stirrer, was filled with ammonium sulfate (40% aqueous solution, 75.5 g; brine solution), acrylamide (7.5 g; nonionic monomer), polydiallyldimethylammonium chloride (poly-DADMAC) (20%, 12.0 g; stabilizer) and de-ionized water (20.0 g). The mixture was purged with N₂ for 30 minutes before it was heated to 35° C. A solution of 2,2′-azobis[2-(2-imidazoline-2-yl)propane] dihydrochloride (VA-044; catalyst) [5.0 mg in water (5.0 g)] was injected into the mixture within the flask. The reaction was kept at 35° C. under N₂ and stirring [rotation per min (rpm)=300] for 22 hours, and then cooled to room temperature. A dispersion of particles was obtained having a solids content of approximately 33 wt. % and a polymer content of approximately 8 wt. %.

### Example 2

### Preparation of an Anionic Brine Dispersion Polymer (ID: JW05)

The following procedure was followed to prepare an anionic brine dispersion polymer, referred to herein as “JW05,” including 95 wt % (96 mol %) of a nonionic monomer and 5 wt % (4 mol %) of an anionic monomer. A three-neck flask (250 mL), equipped with a condenser and a mechanical stirrer, was filled with acrylamide (6.750 g; nonionic monomer), sodium acrylate (0.750 g; anionic monomer), polydiallyldimethylammonium chloride (poly-DADMAC) (20 wt. %, 12.0 g; stabilizer) and ammonium sulfate (40 wt. % solution, 95.5 g; brine solution). The mixture was purged with N₂ for 30 minutes before it was heated to 35° C. A solution of 2,2′-azobis[2-(2-imidazoline-2-yl)propane] dihydrochloride (VA-044) [0.50 mg in water (5.0 g); catalyst] was injected into the mixture within the flask. The reaction was kept at 35° C. under N₂ and stirring [rotation per minutes (rpm)=300] for 22 hours before it was cooled to room temperature. The resultant dispersion of particles, having a solids content approximately 40 wt. % and a polymer content of approximately 8 wt. %. The dispersion was filtered by an 80 mesh stainless steel sieve before storage.

### Example 3

### Friction Reduction Measurements

A flow loop with an outside diameter of 1 inch and an internal capacity of approximately 6.0 L was employed. A differential pressure meter was used across one of the 7-foot long sections. The amount of friction reduction (error: approximately 1%) was calculated from the change of differential pressure after injecting any one of the polymers. A KCl solution (2 wt. %, 6.0 L) was circulated in the loop at either 125 L/min. or 145 L/min. as specified in each run. The temperature of the flow loop was maintained constant at approximately 38° C. (100° F.).

### Example 4

### Comparative Friction Reductions

The amount of friction reduction was evaluated for both the nonionic dispersion polymer (JW00; acrylamide homopolymer of Example 1) and the anionic brine dispersion polymer (JW05; acrylamide copolymer with sodium acrylate 5 wt. % of Example 2).

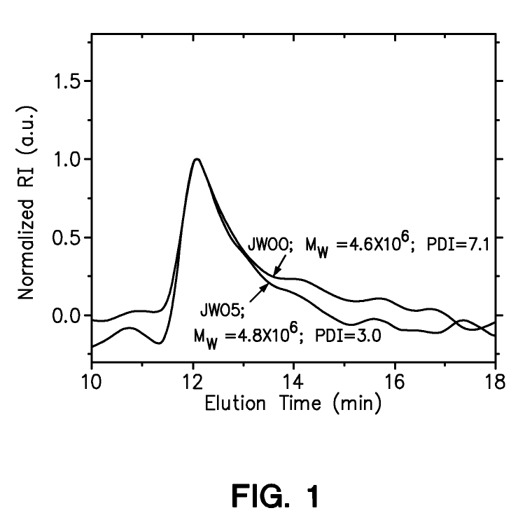

FIG. 1 is a graph of gel permeation chromatography (GPC) profiles of a nonionic dispersion polymer (JW00) and an anionic dispersion polymer having about 10 mol % anionic monomer (JW05). As shown, the two dispersion polymers had essentially identical molar mass (approximately 5.0×10⁶; cf. FIG. 1).

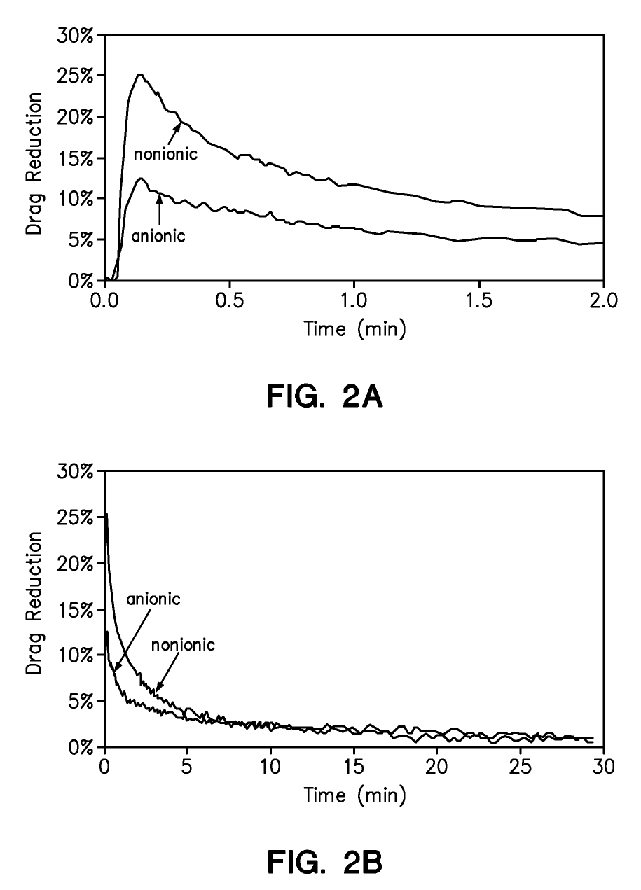

FIGS. 2A and 2B are graphs of friction reduction over periods of 2 minutes and 30 minutes, respectively, resulting from the use of a nonionic dispersion polymer (JW00) and the anionic dispersion polymer (in NaCl 2 wt %, 15 mL). Both polymer dispersions were used at dosages of 15 ppm, a brine flow rate of 125 L/minute, and a temperature of approximately 38° C. (100° F.). As shown in the graphs, the nonionic dispersion polymer (JW00) performed better than the anionic dispersion polymer (JW05). The maximum friction reduction (peak value) by JW00 was approximately 25%, in contrast to a 12% friction reduction by JW05 (FIG. 2). These results are surprising since it was against the general belief that polymers with higher molar masses should lead to greater friction reduction (Ionic polymers were favored probably due to added “molar masses” arising from charge repulsion).

### Example 5

### Effect of Initial State of Polymer on Friction Reduction

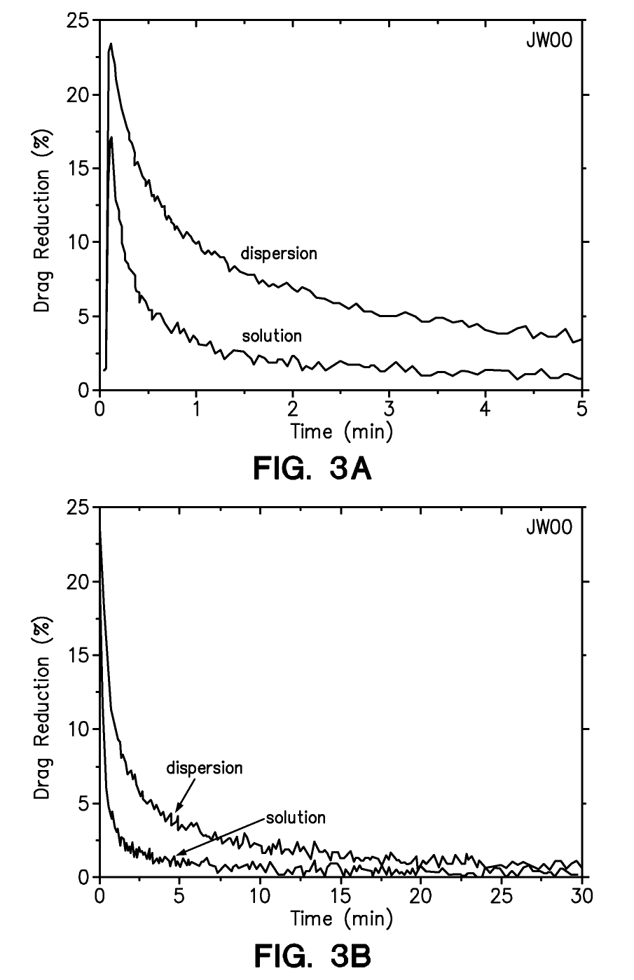

A polymer solution was formed by diluting a nonionic dispersion polymer in order to examine the effect of the initial state of the nonionic dispersion polymer (JW00) on friction reduction. FIGS. 3A and 3B are graphs of friction reduction (“decay profiles”) over periods of 5 minutes and 30 minutes, respectively, resulting from the use of the nonionic dispersion polymer (JW00) as a dispersion of polymer particles and the nonionic polymer solution (dissolving the JW00 dispersion polymer particles into a solution) based on the same nonionic polymer in the flow loop described in Example 3. Both the dispersion polymer (used as a dispersion of polymer particles) and the polymer solution (by dissolving the original polymer particles into a solution) were used at dosages of 15 ppm, a brine flow rate of 145 L/minute, and a temperature of approximately 38° C. (100° F.). Throughout the decay profiles, friction reduction by the dispersion polymer is higher than that by the polymer solution, although exactly the same polymers were applied at the same dosage (15 ppm based on total fluid) and identical conditions. For example, the maximum friction reduction by the JW00 dispersion polymer was 24%, while that by the corresponding polymer solution was only 17%.

### Example 6

### Compatibility with Multi-valence Brine

The flow loop described Example 3 was used to measure the amount (%) of friction reduction (error: approximately 1%) resulting from injection of the nonionic disperson polymer (JW00) into a multi-valence brine. A KCl (2 wt. %) and CaCl₂ (0.5%) solution (6.0 L) was circulated in the loop at 125 L/minute. The temperature of the flow loop was maintained constant at approximately 38° C. (100° F.).

A nonionic brine dispersion polymer was again prepared in accordance with Example 1 (ID: 0801-2007B; NB#2; molar mass of approximately 4.3×10⁶; PDI≅4.7) and injected to the loop. The results indicate that the polyacrylamide brine dispersion polymer was able to maintain its performance within a multi-valence brine. The maximum friction reduction by this dispersion polymer is approximately 29%, which is comparable to that by another nonionic polymer of JW00 (molar mass of approximately 4.6×10⁶).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of reducing friction resulting from turbulent flow in an aqueous fluid comprising:
adding a friction-reducing amount of one or more nonionic dispersion polymers into the aqueous fluid, wherein the one or more nonionic dispersion polymers have a molecular weight of at least 100,000.

2. The method of claim 1, wherein the one or more nonionic dispersion polymers comprise an acrylamide polymer.

3. The method of claim 1, wherein the aqueous fluid is selected from fresh water, mono-valence brine, multi-valence brine, and aqueous acids.

4. The method of claim 1, further comprising:
adding one or more charged species into the aqueous fluid, wherein the one or more nonionic dispersion polymers do not ionically interact with the charged species.

5. The method of claim 4, wherein the one or more charged species includes a corrosion inhibitor.

6. The method of claim 4, wherein the one or more charged species includes a biocide.

7. The method of claim 1, wherein the dispersion polymer is formed in an aqueous brine solution.

8. A method of reducing friction resulting from turbulent flow in an aqueous fluid comprising:
adding a friction-reducing amount of one or more dispersion polymers into the fluid, wherein the dispersion polymer has a molecular weight of at least 100,000, and wherein the dispersion polymer comprises no less than 96 mole percent of one or more nonionic monomers and no greater than 4 mole percent of one or more ionic monomers.

9. The method of claim 8, wherein the one or more ionic monomer comprises a cationic monomer selected from dimethylaminoethyl acrylate methyl chloride quaternary salt and dimethylaminoethyl acrylate benzyl chloride quaternary salt.

10. The method of claim 8, wherein the one or more ionic monomer comprises an anionic monomer selected from the group consisting of acrylic acid, methacrylic acid and 2-acrylamido-2-methylpropanesulfonic acid and the salts thereof.

11. The method of claim 8, wherein the nonionic monomer is acrylamide.

12. The method of claim 8, further comprising:
adding a corrosion-inhibiting amount of one or more charged corrosion inhibitors into the aqueous fluid, wherein the one or more nonionic dispersion polymers do not ionically interact with the one or more charged corrosion inhibitors.

13. The method of claim 8, wherein the dispersion polymer is formed in an aqueous brine solution.

14. An aqueous treatment fluid, comprising:
a friction-reducing amount of one or more dispersion polymers, wherein the dispersion polymer comprises from 96 to 100 mole percent of one or more nonionic monomers and from 0 to 4 mole percent of one or more cationic or anionic monomers; and wherein the dispersion polymer has a molecular weight of at least 100,000.

15. The aqueous treatment fluid of claim 14, wherein the water is selected from the group consisting of freshwater, saltwater, brine, seawater and combinations.

16. The aqueous treatment fluid of claim 14, wherein the dispersion polymers are selected from oil-external, water-external or combination.

17. The aqueous treatment fluid of claim 14, further comprising:
corrosion inhibitors, biocides and combinations.

18. The aqueous treatment fluid of claim 14, wherein the dispersion polymer comprises 100 mole percent of the one or more nonionic monomers.

19. The aqueous treatment fluid of claim 18, wherein the dispersion polymer comprises an acrylamide polymer.

20. The aqueous treatment fluid of claim 19, wherein the dispersion polymer is formed in an aqueous brine solution.
